(19) United States
(12) Patent Application Publication
(10) Pub. No.: US 2023/0375414 A1
(43) Pub. Date: Nov. 23, 2023

(54) TEMPERATURE SENSOR

(71) Applicant: WIKA Alexander Wiegand SE & Co. KG, Klingenberg/Main (DE)

(72) Inventors: Juergen BRAEUTIGAM, Elsenfeld (DE); Andreas COHRS, Unna (DE); Joachim EISENTRAEGER, Sulzbach (DE); Alexander PAULITSCH, Ludwigshafen (DE)

(73) Assignee: WIKA Alexander Wiegand SE & Co. KG, Klingenberg/Main (DE)

(21) Appl. No.: 18/199,605

(22) Filed: May 19, 2023

(30) Foreign Application Priority Data
May 23, 2022 (DE) 10 2022 112 975.6

(51) Int. Cl. G01K 1/08; G01K 1/14; G01K 13/02

(52) U.S. Cl. CPC G01K 1/08; G01K 1/14; G01K 13/02

(57) ABSTRACT

A temperature sensor having a support tube with a distal end having a first distal opening, with a proximal end having a first proximal opening and with a channel extending between the openings. The temperature sensor further comprises a sensing element, which is inserted through the first proximal opening into the channel and passes through it, so that a measuring tip of the sensing element passes through the first distal opening and protrudes beyond the distal end of the support tube, at least in sections. The support tube has a first fastening area on or near the distal end and a second fastening area on or near the proximal end. The sensing element is directly or indirectly tightly sealed to the support tube by solder joints on the first and second fastening areas.

This nonprovisional application claims priority under 35 U.S.C. § 119(a) to German Patent Application No. 10 2022 112 975.6, which was filed in Germany on May 23, 2022, and which is herein incorporated by reference.

### BACKGROUND OF THE INVENTION

### Field of the Invention

The invention relates to a temperature sensor for measuring the temperature of media, in particular flowing media and/or media in industrial process plants. The invention further relates to a method for producing such a temperature sensor.

### Description of the Background Art

In order to determine a temperature of a process medium exactly, it is often necessary that a sensitive sensing element, such as a thermistor or a thermocouple joint, is placed in the process medium at a distance from a wall of a vessel or tube that surrounds or guides a process medium. In the vicinity of the wall, the process medium can often be cooler due to heat dissipation into the environment. For this purpose, numerous devices are known from the conventional art, which include a sensing element which is inserted into a so-called thermowell, wherein the thermowell in turn protrudes into the vessel or tube that contains or guides the process medium. The thermowell should protect the sensing element from damage and impairment by the process medium. In particular, the thermowell should counteract a buckling or tearing in strongly flowing process media. The disadvantage of such devices is that the solid thermowell represents a greater thermal resistance, so that the sensing element only detects changes in the temperature of the process medium with a greater delay. This is also referred to as a longer response time.

From DE 10 2017 207 006 A1 a temperature sensor is known, which is intended to counteract this disadvantage by the fact that the thermowell has an outlet opening at its distal end, through which a section of the sensing element protrudes beyond the distal end of the thermowell and can thus come into direct contact with the process medium. Such a thermowell is also referred to as a support tube.

### SUMMARY OF THE INVENTION

It is therefore an object of the invention to provide a novel temperature sensor as well as a novel method for producing such a device.

In the following, the medium whose temperature is to be measured may therefore also be referred to as the process medium.

In an example, a temperature sensor is provided comprising a support tube with a distal end having a first distal opening, with a proximal end having a first proximal opening, and with a first channel extending between the openings. Furthermore, the temperature sensor includes a first sensing element. The first sensing element comprises, for example, a sheathed cable with a closed distal end, which forms a measuring tip, wherein at least one temperature sensor is brought directly to or near the measuring tip within the sheathed cable and arranged there. This temperature sensor is, for example, a resistance thermometer, e.g., a platinum resistor, or a thermocouple junction. The sheathed cable, for example, is made of stainless steel and filled with a mineral powder to insulate the sensor cables running through it, in particular thermocouple wires.

Distal ends of the support tube or openings on it may be referred to those which face the process medium, in particular are in direct contact with or adjacent to the process medium. Those ends of the support tube or those openings on it that are facing away from the process medium, in particular that are not in direct contact with the process medium and/or do not immerse themselves in the process medium, may be referred to as proximal.

In the present case, if a reference is made to a first sensing element, the first channel, the first distal opening and the first proximal opening, this does not necessarily mean that there are or are no further sensing elements, channels, distal openings and/or proximal openings. The chosen terminology serves only to distinguish the sensing element, the channel, the distal opening and the proximal openings from any other sensing elements, channels, distal openings and/or proximal openings that may be present in examples of the temperature sensor.

The first sensing element is inserted into the first channel through the first proximal opening and penetrates it, so that a measuring tip of the first sensing element passes through the first distal opening and protrudes beyond the distal end of the support tube, at least in sections. The support tube has a first fastening area on or near the distal end and a second fastening area on or near the proximal end. The first sensing element is directly or indirectly tightly sealed to the support tube by solder joints on both the first and second fastening areas.

Alternatively, the element described as a “support tube” can also be referred to as a thermowell, especially in view of the prior art mentioned in the previous section. The term “support tube” was chosen in the context of the invention in order to conceptually distinguish the element from conventional thermowells, which completely enclose the first sensing element inserted into them and have no opening on their distal end. However, the support tube of the present invention may comprise not only the first proximal opening on the proximal end, but also the first distal opening on the distal end. The first sensing element is inserted through the first proximal opening into the first channel of the support tube and passes through it, so that a measuring tip passes through the first opening on the distal end and protrudes beyond the distal end. As a result, the support tube does not necessarily have to completely enclose the first sensing element, but only in sections, namely along the section that lies between the two openings and passes through the first channel. The present temperature sensor has the advantage that it combines a fast response time and high measurement accuracy with high reliability and safety. The fast response time and high measurement accuracy are achieved by the fact that the measuring tip of the first sensing element protrudes beyond the first distal end of the support tube and can thus come into direct contact with the process medium when the temperature sensor is inserted into a vessel or pipeline of a process plant in which the process medium is held or through which the process medium flows. At the same time, the solder joints ensure particularly reliable and tight connections. The solder joint on the first fastening area effectively ensures that the process medium cannot penetrate through the first distal opening of the support tube into the first channel. The solder joint on the second fastening area effectively ensures that even if the process medium enters on the first distal end or if the support tube breaks, the process medium cannot escape through the first proximal opening on the proximal end of the support tube and thus leave the process plant. The temperature sensor can therefore effectively prevent the process medium from escaping even in the event of a fault and thus reduce the risk of hazards.

The production of solder joints can generally be referred to as the soldering process.

An intermediate section of the first channel extends between the first and second fastening areas, wherein along the intermediate section, the support tube and the first sensing element may not be connected, in particular do not touch each other along this intermediate area. In this example, the first sensing element can be thermally decoupled from the support tube along the intermediate section in an advantageous manner, so that a higher measurement accuracy can be possible. Furthermore, the installation of the first sensing element in the support tube is facilitated, since when the first sensing element is inserted into the first channel along the intermediate section, the risk of jamming or canting between the first sensing element and the inner walls of the first channel is reduced. As explained above, the two separate fastening areas ensure a high level of process reliability, as the process medium would have to break through two barriers before it could escape. At the same time, this increased process reliability can be achieved cost-effectively, easily and reliably, since an uninterrupted solder joint between the first sensing element and the support tube does not have to be produced along the entire length of the support tube, but only along the separate fastening sections that are limited in length.

For example, at least one of the two solder joints can be a vacuum brazed joint. Both solder joints, i.e., both the solder joint on the first fastening area and the solder joint on the second fastening area, can be vacuum brazed joints. Vacuum brazed joints can be solder joints that are manufactured under vacuum. Vacuum brazing can advantageously prevent or at least reduce impairments caused by oxidation effects, impurities or air pockets in the solder. Thus, the vacuum brazed joints on the first and/or second fastening area are of particularly high quality and durability.

The production of vacuum brazed joints can be generally referred to as the vacuum brazing process.

The vacuum brazed joints can comprise a flux-free solder or are fabricated with a flux-free solder. This can effectively prevent inclusions of flux or flux residues within the solder joint from weakening it or causing leaks. Due to the fact that the solder joints are produced under vacuum, oxidation effects can be effectively prevented either way, as already mentioned in a previous section. In combination with flux-free solder, a joint of particularly high quality can be achieved. For example, a flux-free nickel-based solder can be used.

The intermediate section of the first channel can be evacuated. In this way, it can be advantageously achieved that the first sensing element along this intermediate section is particularly strongly thermally insulated from the support tube, which can have a positive effect on the measurement accuracy and long-term stability of the first sensing element. Furthermore, the first sensing element can be prevented from being influenced by gases within the intermediate section. The evacuation of the intermediate section can be achieved particularly advantageously if the solder joints are produced under vacuum, i.e., if vacuum brazed joints are produced. During the vacuum brazing process, the intermediate section can be automatically evacuated and can be closed on both sides by the solder joints.

The solder joints, for example the vacuum brazed joints, can extend at least substantially over the entire length of the first fastening area and/or the entire length of the second fastening area. The respective fastening area can have a length of at least one millimeter, preferably a length of at least 8 mm, especially preferably a length of at least 10 mm. Such a large joint length or depth can be used to achieve a particularly reliable and durable seal and connection. Even if, for example, there are mechanical or chemical impairments by the process medium on the outer edge of the solder joint on the first fastening area, penetration of the process medium into the first channel can be effectively and permanently prevented by the solder joint extending over the entire length of the fastening area.

At least one of the two fastening areas can comprise a first section of the first channel, which encloses the first sensing element in a defined manner. Here, and in the context of this document, “encloses in a defined manner” means that an inner diameter of the first section of the first channel can be matched to the outer diameter of the first sensing element in such a way that a defined annular gap results when the first sensing element is inserted into the first section of the first channel. This first section of the first channel can also be referred to as the first channel section or simply the first section. At one end of this first channel section is a first solder reservoir. A solder reservoir can be considered to be any geometry which is suitable for accommodating a solder material and which is arranged in such a way that the solder can flow into or can be fed into gaps provided for this purpose, for example annular gaps, during the soldering process, in particular vacuum brazing processes. As a result, the solder joint, particularly the vacuum brazed joint, can be reliably and easily automated or partially automated. The first solder reservoir can be filled with solder before the soldering process, especially the vacuum brazing process. Preferably, during the soldering process, especially the vacuum brazing process, the temperature sensor should be oriented such that the solder reservoir is located vertically above the first section. As a result, the solder liquefying during the soldering process, especially the vacuum brazing process, can flow into the annular gap resulting from the defined enclosing of the first sensing element through the first section of the first channel, and no other means or mechanisms are required. In this way, it is particularly advantageous to ensure that the solder joints, in particular the vacuum brazed joints, extend over the entire length of the fastening sections. Thus, the solder should have flowed completely into the annular gap between the first section of the first channel and the first sensing element and should fill it evenly over the entire length of the first section.

The first section can have an inner diameter which is not more than 0.5 mm, preferably not more than 0.1 mm, especially preferably not more than 0.03 mm larger than the outer diameter of the first sensing element in the area of the first section. Such sizing enables a particularly reliable, uniform and durable solder joint, especially a vacuum brazed joint, between the first section and the first sensing element.

The defined enclosing of the first sensing element through the first section can extend over a length of at least 1 mm, preferably at least 8 mm, especially preferably at least 10 mm. Preferably, the resulting annular gap between the first section and the first sensing element is completely filled by the solder over this length, thus connecting these parts tightly to each other.

The first section of the first channel can be followed by the intermediate section, wherein the intermediate section has a larger inner diameter than the first section, at least in sections. The first solder reservoir can be formed particularly simply by a transition area or a simple step between the first section and the intermediate section. This makes the support tube with intermediate section, first solder reservoir and first section of the first fastening area particularly easy and cost-effective to manufacture. For example, the inner diameter of the intermediate section may be at least 0.05 mm larger, preferably at least 0.1 mm larger, and preferably at least 1 mm larger than the inner diameter of the first section of the first channel. In this way, a sufficiently large amount of solder can be absorbed through the step or transition area between the intermediate section and the first section to achieve a stable solder joint between the parts in the soldering process, especially the vacuum brazing process. Furthermore, the advantages of an evacuated intermediate section described in a previous section can be exploited particularly effectively by such dimensioning.

At least one of the two fastening areas can include a second section of the first channel and a connecting sleeve. This second section of the first channel can also be referred to as the second channel section or simply as the second section. The connecting sleeve can enclose the first sensing element in a defined manner, and the second section of the first channel in turn can enclose the connecting sleeve in a defined manner. Here, “encloses in a defined manner” may mean that an inner diameter of the second section of the first channel is matched to the outer diameter of the connecting sleeve and that an inner diameter of the connecting sleeve is matched to the outer diameter of the first sensing element in such a way, that in each case defined annular gaps result between the elements when the first sensing element is inserted into the connecting sleeve and the connecting sleeve is inserted into the second channel section at the same time. At one end of the second section, a second solder reservoir can be arranged. As a result, the solder joint, especially the vacuum brazed joint, can be reliably and easily automated or partially automated. The second solder reservoir can be filled with solder before the soldering process, especially the vacuum brazing process. During the soldering process, especially the vacuum brazing process, the temperature sensor can be oriented such that the second solder reservoir is vertically above the second section. As a result, the solder liquefying during the soldering process, especially the vacuum brazing process, can flow into the two annular gaps, which result from the defined enclosing of the first sensing element by the connecting sleeve and from the defined enclosing of the connecting sleeve by the second section of the first channel. In this way, for example, the above-mentioned advantageous property can be reliably achieved, namely that the solder joint, in particular the vacuum brazed joint, can extend over the entire length of the fastening sections. This can mean that the solder has flowed completely into the two annular gaps and fills them evenly over the entire length of the second section or the connecting sleeve.

The second section can have an inner diameter which is not more than 0.5 mm, preferably not more than 0.1 mm, and preferably not more than 0.03 mm larger than the outer diameter of the connecting sleeve. Such sizing allows for a particularly reliable, uniform and durable solder joint, especially a vacuum brazed joint, between the second section and the connecting sleeve.

The connecting sleeve can have an inner diameter which is not more than 0.5 mm, preferably not more than 0.1 mm, especially preferably not more than 0.03 mm larger than the outer diameter of the first sensing element. Such dimensioning enables a particularly reliable, uniform and durable solder joint, especially a vacuum brazed joint, between the connecting sleeve and the first sensing element.

The defined enclosing of the first sensing element can extend through the connecting sleeve and the second section over a length of at least 1 mm, preferably of at least 8 mm, especially preferably of at least 10 mm. Preferably, the resulting annular gaps between the second section and the connecting sleeve, as well as between the connecting sleeve and the first sensing element, can be completely filled by the solder over this length, thus connecting these parts tightly to each other.

The first fastening area can comprise the first section of the first channel, which encloses the first sensing element in a defined manner, as described above. On one side of the first section facing away from the distal end, the intermediate section of the first canal adjoins the first section, wherein the intermediate section has a larger inner diameter than the first section. The step between the first section and the intermediate section may form the first solder reservoir, in which a solder, e.g., in the form of a ring of solder material, can be placed before the soldering process, especially the vacuum brazing process. The second fastening area can include the second section of the first channel and the connecting sleeve, wherein the connecting sleeve can enclose the first sensing element in a defined manner and the second section of the first channel can enclose the connecting sleeve in a defined manner, as described above. The second solder reservoir can be arranged on the end of the second section facing away from the distal end of the support tube and can be formed by a front face of the connecting sleeve on which a solder, e.g., in the form of a ring of solder material, can be placed before the soldering process, in particular the vacuum brazing process. If, the temperature sensor is oriented such that the distal end points vertically downwards and the proximal end vertically upwards, the first solder reservoir can be located directly above the first section and the second solder reservoir can be located directly above the second section and the connecting sleeve. Thus, both solder joints can be produced as part of a joint soldering process, in particular a vacuum brazing process, without the device having to be realigned in the meantime or re-equipped with solder material. In this example, the temperature sensor can therefore be manufactured particularly cost-effectively.

The proximal end of the support tube can be connected to or includes a connecting piece. This makes it advantageous to adapt the temperature sensor to a large number of conceivable connections and to use it in a wide range of applications. For example, the connecting piece may have a flange connection, a screw connection (e.g., screw-in connection), a so-called Vanstone connection or a weld-on connection.

The proximal end of the support tube can be connected to the connecting piece in one piece, i.e., the support tube and connecting piece can be made of a basic part, such as a forged blank. This is particularly robust and resilient, as the one-piece nature does not require any joints, such as solder joints, which would otherwise represent potential weak points.

The support tube and the connecting piece can be separate parts, wherein the connecting piece can have a passage and a through hole, respectively, and the proximal end of the support tube can be disposed in or on that passage. In this context, an arrangement “in this passage” can mean that the support tube may completely penetrates the passage, i.e., that the support tube protrudes beyond the connecting piece, at least in sections, on both sides of the passage. An arrangement “on this passage”, on the other hand, can mean that the proximal end of the support tube is only inserted into a recess on the passage or even rests only on one side surface of the connecting piece, so that the passage and the second opening overlap at least in sections. For example, the support tube may have a shoulder that rests against a side surface of the connecting piece or an edge of the passage. In this arrangement, the two parts can be connected to each other by a screw connection and/or a solder joint, in particular a vacuum brazed joint, and/or one or more welded joints. This example is characterized by particularly cost-effective production from a few individual parts, while still achieving high stability and resilience.

The connecting piece can also have a passage and the proximal end of the support tube may be arranged in this passage so that the support tube protrudes beyond the connecting piece, at least in sections, on both sides thereof. The support tube can be tightly and stably connected to the connecting piece by welded joints on both sides. Between these welded joints, a closed space can be formed between the support tube and the passage of the connecting piece, for example in the form of an annular gap. The connecting piece or support tube have a test bore extending from one side of the connecting piece or support tube facing away from the distal end of the support tube to that space. It is also possible that a test bore can be formed on the proximal end of the support tube, which is connected to the intermediate section, wherein the connecting piece has access to the test bore. Also, the test bore can be formed on the proximal end of the support tube if no connecting piece is provided. The test bore can be used to reliably monitor whether the welded joints are still intact and/or whether, for example, a process medium has penetrated the intermediate space. Such monitoring can be realized, for example, by evacuating the intermediate space and connecting a pressure sensor to the intermediate space via the test bore. In this way, damage or faults can be detected at an early stage and a risk of danger can be reduced.

The support tube can have a conical outer contour that tapers from the proximal to the distal end and/or the support tube can have a spiral structure in or on its outer surface, at least in sections, and/or the support tube can have an outer diameter that periodically changes along the length of the support tube. This enables particularly high reliability and stability, even when used in fast-flowing process media. Due to the thickness or outer contour that changes over the length of the support tube, the excitation of vibrations by vortex formation is strongly suppressed.

The support tube can comprise at least a second distal opening on the distal end, at least a second proximal opening on the proximal end, at least a second channel extending between the second distal opening and the second proximal opening, and at least a second sensing element. In this case, the support tube can have a third fastening area on or near the distal end and a fourth fastening area on or near the proximal end. The second sensing element can be inserted into the second channel through the second proximal opening and penetrates it, so that a measuring tip of the second sensing element passes through the second distal opening and protrudes beyond the distal end of the support tube, at least in sections. The second sensing element may be directly or indirectly tightly sealed to the support tube by solder joints on the third and fourth fastening areas. In this example, the temperature of the process medium can be measured at least with the help of the first and second sensing elements. This redundancy can further increase the safety of process monitoring: Even if one of the two sensing elements should fail, the temperature of the process medium can be continuously monitored due to the redundant sensing element. Furthermore, it is advantageously possible to compare the sensor signals of both temperature sensors continuously, or periodically. Since the measuring tips of the sensing elements are arranged close to each other and are in direct contact with the process medium on the distal end of the support tube, they are exposed to practically identical environmental influences, especially identical temperatures. However, if the sensor signals deviate from each other, or if a difference in the sensor signals changes, this may indicate an impairment of at least one of the sensors. Thus, with at least two sensing elements, such an impairment can be reliably detected and appropriate repair or corrective measures can be initiated.

A second intermediate section of the second channel can extend between the third and fourth fastening areas, wherein along the second intermediate section, the support tube and the second sensing element are not connected. By such, the advantages of a stronger thermal decoupling between the second sensing element and the support tube as well as a facilitated installation of the second sensing element in the second channel can be achieved while at the same time maintaining undiminished process reliability and simple, cost-effective production. Here, too, a particularly strong thermal decoupling can be advantageously achieved by evacuating the second intermediate section. The example and arrangements explained herein can also be applied analogously to at least the second channel, the second sensing element, the second proximal opening, the second distal opening, the third and fourth fastening areas, as well as the second intermediate area in order to achieve the respective advantageous effects.

A method for producing a temperature sensor is also provided. The method can include the provision of a support tube with a distal end having a first distal opening, with a proximal end having a first proximal opening, and/or with a first channel extending between these two openings.

A first sensing element, for example a temperature sensor wrapped in a mineral-insulated sheathed cable, can be inserted through the first proximal opening into the first channel and pushed through the first channel so that the first sensing element passes through the first channel and at least one measuring tip of the first temperature sensing element can pass through the first distal opening on the distal end and protrudes beyond the distal end of the support tube, at least in sections. In this case, there is a first fastening area on or near the distal end and a second fastening area on or near the proximal end.

Solder joints can be produced between the support tube and the first sensing element on the two fastening areas.

By means of this method, temperature sensors can be manufactured cost-effectively, efficiently and reliably. In doing so, the products of this manufacturing method can effectively achieve the advantages of the temperature sensor described in the preceding sections according to the first aspect of this invention.

In an further development of the method for the manufacture of temperature sensors, the first fastening area can comprise a first section of the first channel, which encloses the support tube in a defined manner and wherein a first solder reservoir can be arranged at one end of the first section, and/or the second fastening area includes a second section of the first channel and a connecting sleeve, wherein the connecting sleeve can enclose the first sensing element in a defined way and the second section encloses the connecting sleeve in a defined way and wherein a second solder reservoir is disposed at one end of the second section. The term “encloses in a defined manner” can be understood accordingly, as described in the preceding sections. Further, the following steps can be carried out between a step of inserting the first sensing element into the support tube and a step of producing the solder joints, by placing solder material in or on the first solder reservoir and/or placing solder material in or on the second solder reservoir. The solder material can be used, for example, in the form of rings made of solder material.

The first and second solder reservoirs can be arranged either both at one end facing away from the distal end or both at one end facing the distal end of the first section and the second section, respectively. Due to this design, in a further step for the production of the solder joints, the temperature sensor can be aligned in such a way that both solder reservoirs are simultaneously vertically located above their respective assigned section of the first channel, i.e., that the first solder reservoir is located vertically above the first section and the second solder reservoir is located vertically above the second section. If a soldering process is then carried out and the solders liquefy in the process, they flow by gravity directly into the annular gaps formed between the first section and the first sensing element or between the second section and the connecting sleeve and between the connecting sleeve and the first sensing element. Thus, with this further development of the method, a temperature sensor can be manufactured particularly efficiently, reliably and cost-effectively.

For the production of temperature sensors, the solder joints can be vacuum brazed joints, that is, the solder joints can be produced under vacuum, i.e., by a vacuum brazing process.

The disclosure content of this document is not limited to the features of the above-mentioned exemplary embodiments and/or further developments, but also includes any combination of these features, insofar as they are not logically mutually exclusive.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of a temperature sensor in a sectional view,

FIGS. 2A, 2B, 3A and 3B are examples of a first fastening area before and after a soldering process,

FIGS. 4A, 4B, 5A and 5B examples of a second fastening area before and after a soldering process,

FIG. 6 shows an example a temperature sensor in a sectional view,

FIGS. 7A and 7B show various examples of a temperature sensor,

FIG. 8 shows an example of a temperature sensor in a sectional view,

FIG. 9 shows an example of the temperature sensor in a sectional view, and

FIG. 10 shows an example of a temperature sensor in a sectional view.

### DETAILED DESCRIPTION

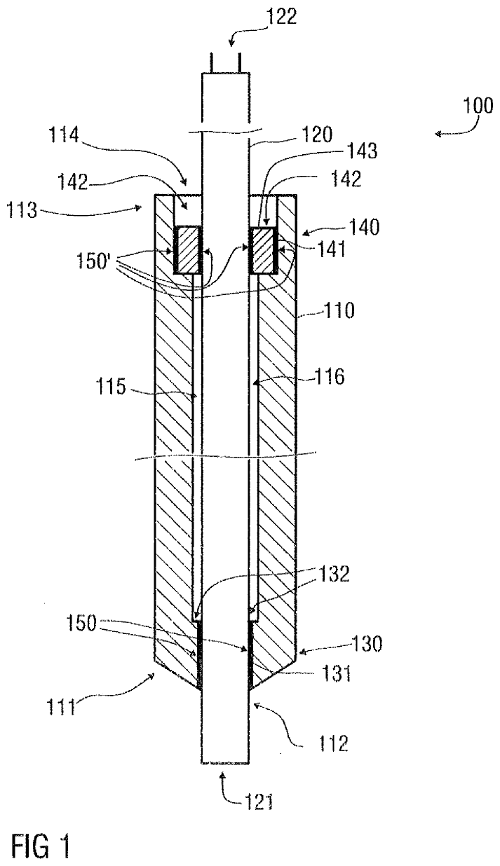

FIG. 1 shows an example of a temperature sensor 100. It comprises a support tube 110 with a distal end 111 having a first distal opening 112 and with a proximal end 113 having a first proximal opening 114. Between the openings 112, 114 there is a first channel 115, which includes a first fastening area 130, an intermediate section 116 and a second fastening area 140. A first sensing element 120 is inserted through the first proximal opening 114 into the first channel 115 and passes through it, so that a measuring tip 121 of the first sensing element 120 passes through the first distal opening 112 and protrudes beyond the distal end 111 of the support tube 110. The support tube 110 is tightly connected to the first sensing element 120 by solder joints 150, 150′ on the first and second fastening areas 130, 140. For example, these solder joints 150, 150′ are vacuum brazed joints.

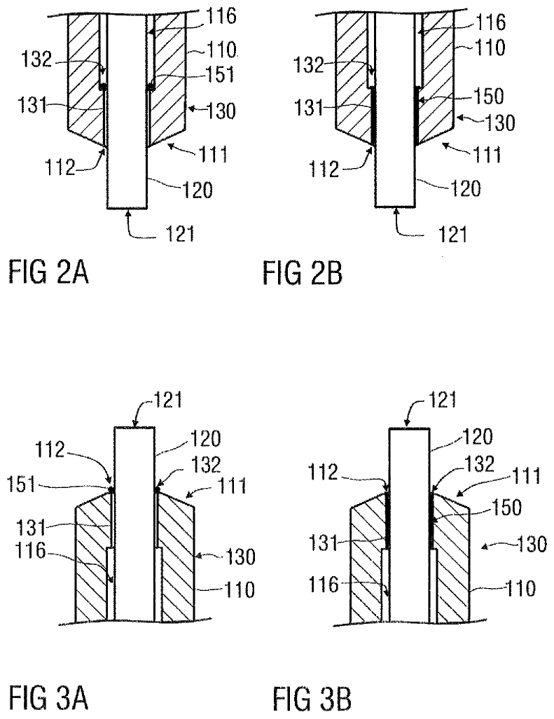

In this example, the first fastening area 130 comprises a first section 131 of the first channel 115, which encloses the first sensing element 120 in a defined manner. This first section 131 is followed by the intermediate section 116, which has a larger inner diameter than the first section 131. Due to the step forming between the sections, a first solder reservoir 132 is formed, which is thus vertically located directly above the first area 131. Such a fastening area 130 is shown in detail in FIGS. 2A and 2B.

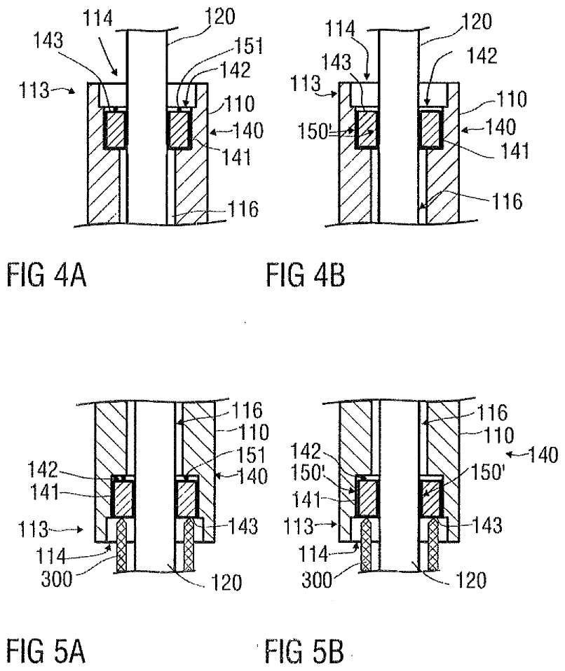

The second fastening area 140 in this example comprises a second section 141 of the first channel 115 and a connecting sleeve 143, wherein the connecting sleeve 143 encloses the first sensing element 120 in a defined manner and the second section 141 of the first channel 115 encloses the connecting sleeve 143 in a defined manner. A second solder reservoir 142 is provided vertically directly above the second section 141 and the connecting element 143. Such a fastening area 140 is shown in detail in FIGS. 4A and 4B.

For example, the first sensing element 120 can be a mineral-insulated sheathed cable within which a sensor is arranged on or near the measuring tip 121. This sensor can be, for example, a resistance thermometer or a junction of two thermocouple wires. At one end of the first sensing element 120, facing away from the measuring tip 121, there are contacts 122 through which the sensor can be connected to an evaluation device which, for example, evaluates an electrical property of the sensor, such as a voltage, a current or a resistance, to a temperature measured value.

FIGS. 2A, 2B, 3A, and 3B each show different examples of the first fastening area 130, while FIGS. 4A, 4B, 5A, and 5B each show different examples of the second fastening area 140. In each case, the figures with the suffix “A” show a respective fastening area 130, 140 before the execution of a soldering process or vacuum brazing process, whereas the figures with the suffix “B” represent a respective fastening area 130, 140 after the execution of a soldering process or vacuum brazing process.

In FIGS. 2A and 2B, the first fastening area 130 on the distal end 111 of the support tube 110 is shown enlarged in a sectional view. The fastening area 130 comprises a first section 131 of the first channel 115, which encloses the first sensing element 120 in a defined manner. The first section 131 is followed by an intermediate section 116, which has a larger inner diameter than the first section 131. As a result of a step resulting between the two sections, a first solder reservoir 132 is formed. As seen in FIG. 2A, solder material can be placed in this solder reservoir 132, e.g., in the form of a ring of solder material 151. If, as in FIGS. 2A and 2B, the support tube 110 is oriented such that the distal end points vertically downwards, the solder reservoir 132 is thus vertically located directly above the annular gap resulting between the first section 131 and the first sensing element 120 on the first fastening area 130. Thus, if the solder material liquefies during a soldering process, especially a vacuum brazing process, it can flow down by gravity into the annular gap and fill it. As shown in FIG. 2B, a complete filling of the annular gap can thus be achieved so that the solder joint 150 produced extends completely over the entire length of the first section 131.

FIGS. 3A and 3B show another example of the fastening area 130 on the distal end 111 of the support tube 110 enlarged in a sectional view. In this example, the solder reservoir 132 is formed by a depression on the distal end 111. Here, solder material, for example in the form of a ring made of solder material 151, can be easily placed. Thus, if the support tube 110, as shown in FIGS. 3A and 3B, is oriented such that the distal end is vertically pointing upwards, the solder reservoir 132 is located vertically directly above the annular gap resulting between the first section 131 and the first sensing element 120 on the first fastening area 130. Thus, if the solder material liquefies during a soldering process, especially a vacuum brazing process, it can flow down by gravity into the annular gap and fill it. As shown in FIG. 3B, a complete filling of the annular gap can be achieved so that the solder joint 150 produced extends completely over the entire length of the first section 131.

In FIGS. 4A and 4B, the second fastening area 140 on the proximal end 113 of the support tube 110 is shown enlarged in a sectional view. The fastening area 140 comprises a second section 141 of the first channel 115 as well as a connecting sleeve 143, wherein the connecting sleeve 143 encloses the first sensing element 120 in a defined manner and the second section 141 of the first channel 115 encloses the connecting sleeve 143 in a defined manner. A second solder reservoir 142 is provided vertically directly above the second section 141 and the connecting element 143. As seen in FIG. 4A, solder material 142 can be placed in this second solder reservoir, e.g., in the form of a ring of solder material 151. If, as in FIGS. 4A and 4B, the support tube 110 is aligned such that the proximal end 113 points vertically upwards, the solder reservoir 142 is thus vertically located directly above the annular gap, which is located between the second section 141 and the connecting sleeve 143 and between the connecting sleeve 143 and the first sensing element 120 on the second fastening area 140. Thus, when the solder material liquefies during a soldering process, especially a vacuum brazing process, it can flow down by gravity into the annular gap and fill it. As shown in FIG. 4B, this allows for a complete filling of both annular gaps, so that the solder joints 150′ produced extend completely over the entire length of the second section 141.

FIGS. 5A and 5B show another example of the fastening area 140 on the proximal end 111 of the support tube 110 enlarged in a sectional view. In this example, the solder reservoir 142 is formed by a chamber within the first channel, which is located at one end of the connecting sleeve 143 facing away from the proximal end 133. Soldering material, for example in the form of a ring made of solder material 151, can be placed here. A schematically depicted holding device 300 holds the connecting sleeve 143 in the desired position before and during the soldering process, in particular the vacuum brazing process, so that it cannot slip down from the second section 141. Thus, if the support tube 110, as shown in FIGS. 5A and 5B, is oriented such that the proximal end points vertically upwards, the solder reservoir 142 is located vertically directly above the annular gap located between the second section 141 and the connecting sleeve 143, and between the connecting sleeve and the first sensing element 120 on the second fastening area 140. Thus, when the solder material liquefies during a soldering process, especially a vacuum brazing process, it can flow down by gravity into the annular gap and fill it. As shown in FIG. 5B, a complete filling of the annular gap can be achieved so that the solder joints 150′ produced extend completely over the entire length of the second section 141.

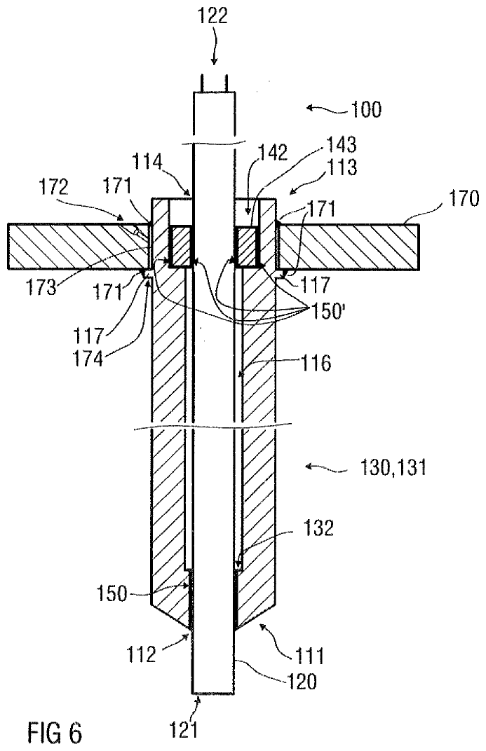

FIG. 6 shows an example of the temperature sensor 100, similar to that in FIG. 1, in a sectional view. In this example, the support tube 110 is connected to a connecting piece 170, which is designed in the form of a flange. The connecting piece 170 has a central breakthrough 174, for example a bore. The support tube 110 has a shoulder 117 at its proximal end 113 and is pushed through the breakthrough 174 so that the shoulder 117 rests on a side of the connecting piece 170 facing away from the distal end 111 of the support tube 110. Support tube 110 and connecting pieces 170 are tightly connected to each other by welded joints 171. Between the welds 171, the breakthrough 174 and the outer circumference of the support tube 110, a space 173 is enclosed. A test bore 172 extends from one side of the connecting piece 170 facing away from the distal end 111 of the support tube 110 to this space 173.

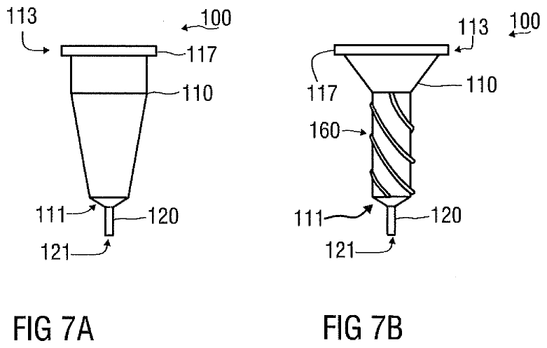

FIGS. 7A and 7B show various examples of the temperature sensor 100 in a side view. In FIG. 7A, the support tube 110 has a conical outer contour, tapering from the proximal end 113 to the distal end 111.

In FIG. 7B, the support tube 110 has a conical section in the region of the proximal end 113, which is followed by a section provided with a spiral structure 160.

Although, in the examples described above, the first fastening region 130 comprises a first section 131, which directly encloses the first sensing element 120 in a defined manner (i.e., without a connecting sleeve 143), and the second fastening area 140 comprises a second section 141 and a connecting sleeve 143, the present invention is not limited to this combination. For example, the arrangement can also be designed in reverse. That is, the first fastening area 130 may comprise a second section 141 and a connecting sleeve 143, while the second fastening area 140 may comprise a first section 131, which directly encloses the first sensing element 120 (i.e., without a connecting sleeve 143) in a defined manner. Likewise, both fastening areas 130, 140 may be designed in the same way, i.e., both may comprise approximately a section of the first channel 115, which encloses the first sensing element 120 in a defined manner, or both, for example, a connecting sleeve 143, which encloses the first sensing element 120 in a defined manner, and a section of the first channel 115, which encloses this connecting sleeve 143 in a defined manner.

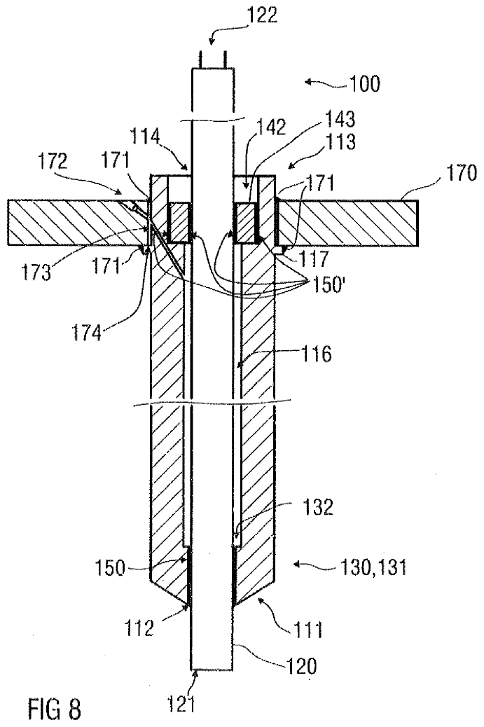

FIG. 8 shows an example of the temperature sensor 100, similar to that in FIG. 6, in a sectional view.

In this example, the support tube 110 is connected to a connecting piece 170, which is designed in the form of a flange. The connecting piece 170 has a central breakthrough 174, for example a bore. The support tube 110 has a shoulder 117 between the proximal end 113 and the distal end 111 and is pushed through the breakthrough 174 from below, so that the shoulder 117 rests against a side of the connecting piece 170, facing the distal end 111 of the support tube 110 or the connecting piece 170 rests on the shoulder 117. Support tube 110 and connecting pieces 170 are tightly connected to each other by welded joints 171. Between the welds 171, the breakthrough 174 and the outer circumference of the support tube 110, a space 173 is enclosed. A test bore 172 extends from one side of the connecting piece 170, facing away from the distal end 111 of the support tube 110 to this space 173 and, starting therefrom, through the support tube 110 into the intermediate section 116. That is, on the proximal end 113 of the support tube 110, a test bore 172 is formed, which is connected to the intermediate section 116, wherein the connecting piece 170 has access to the test bore 172.

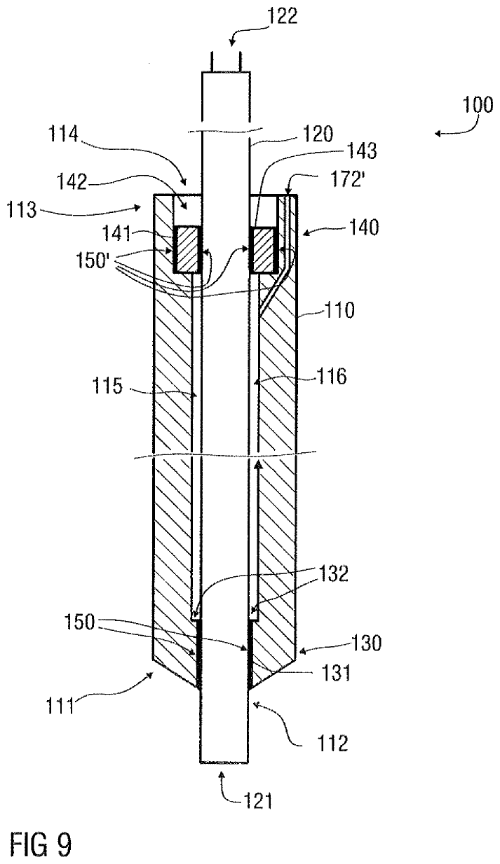

FIG. 9 shows an example of the temperature sensor 100, similar to that in FIG. 1, in a sectional view.

In addition to the example shown in FIG. 1, a test bore 172′, which is connected to the intermediate section 116, is formed on the proximal end 113 of the support tube 110.

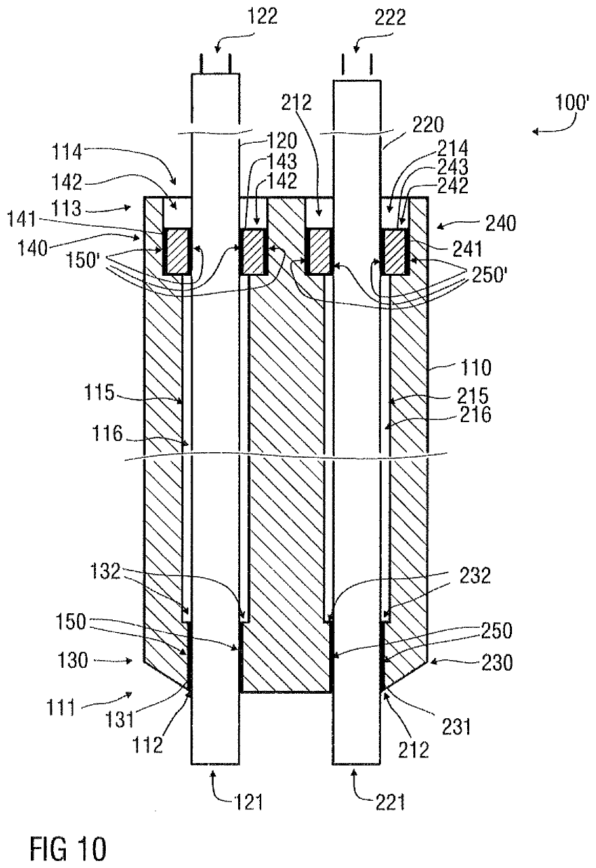

FIG. 10 shows another example of a temperature sensor 100 in a sectional view.

In contrast to the example shown in FIG. 1, the support tube 110 a has a second distal opening 212 at its distal end 111, in addition to the first distal opening 112, and a second proximal opening 214 at its proximal end 113, in addition to the first proximal opening 114.

A second channel 215 extends between the second distal opening 212 and the second proximal opening 214, which comprises a third fastening area 230, an intermediate section 216 and a fourth fastening area 240.

A second sensing element 220 is inserted through the second proximal opening 214 into the second channel 215 and passes through it, so that a measuring tip 221 of the second sensing element 220 passes through the second distal opening 212 and protrudes beyond the distal end 111 of the support tube 110.

The support tube 110 is tightly connected to the second sensing element 220 by solder joints 250, 250′ on the third and fourth fastening areas 230, 240. For example, these solder joints 250, 250′ can be vacuum brazed joints. In the area of the intermediate section 216 of the second channel 215, extending between the third and fourth fastening areas 230, 240, the support tube 110 and the second sensing element 220 are not connected.

In this example, the third fastening area 230 comprises a first section 231 of the second channel 215, which encloses the second sensing element 220 in a defined manner. This first section 231 is followed by the intermediate section 216, which has a larger inner diameter than the first section 231. Due to the step forming between the sections, a first solder reservoir 232 is formed, which is thus vertically located directly above the first area 231. For example, such a fastening area 230 is analogous to the fastening area 130 shown in FIGS. 2A and 2B.

The second fastening area 240 in this example includes a second section 241 of the second channel 215 and a connecting sleeve 243, wherein the connecting sleeve 243 encloses the second sensing element 220 in a defined manner and the second section 241 of the second channel 215 encloses the connecting sleeve 243 in a defined manner. A second solder reservoir 242 is provided vertically directly above the second section 241 and the connecting element 243. For example, such a fastening area 240 is analogous to the fastening area 140 shown in FIGS. 4A and 4B.

For example, the second sensing element 220 can be a mineral-insulated sheathed cable within which a sensor is arranged on or near the measuring tip 221. This sensor can be, for example, a resistance thermometer or a junction of two thermocouple wires. At one end of the second sensing element 220 facing away from the measuring tip 221 there are contacts 222, via which the sensor can be connected to an evaluation device which, for example, evaluates an electrical property of the sensor, such as a voltage, a current or a resistance, to a temperature measured value.

Thus, the invention is not limited to the preceding detailed examples. It can be modified to the extent of the following claims. Likewise, individual aspects from the subclaims can be combined with each other.

What is claimed is:

1. A temperature sensor comprising:
a support tube with a distal end having a first distal opening, with a proximal end having a first proximal opening and with a first channel which extends between the first distal opening and the first proximal opening; and
a first sensing element, which is inserted through the first proximal opening into the first channel and passes through it, so that a measuring tip of the first sensing element passes through the first distal opening and protrudes beyond the distal end of the support tube, at least in sections,
wherein the support tube has a first fastening area on or near the distal end, as well as a second fastening area on or near the proximal end, and
wherein the first sensing element is directly or indirectly tightly sealed to the support tube by solder joints on the first and second fastening areas.

2. The temperature sensor according to claim 1, wherein an intermediate section of the first channel extends between the first and second fastening areas, wherein along the intermediate section, the support tube and the first sensing element are not connected.

3. The temperature sensor according to claim 1, wherein the solder joint on the first fastening area and/or the solder joint on the second fastening region is a vacuum brazed joint produced with a flux-free solder.

4. The temperature sensor according to claim 2, wherein the intermediate section is evacuated.

5. The temperature sensor according to claim 1, wherein the solder joints extend at least substantially over the entire length of the first fastening area and/or over the total length of the second fastening area.

6. The temperature sensor according to claim 1, wherein at least one of the fastening areas comprises a first section of the first channel, which encloses the first sensing element in a defined manner, and wherein a first solder reservoir is arranged at one end of the first section.

7. The temperature sensor according to claim 6, wherein the first section has an inner diameter that is not more than 0.5 mm larger or is not more than 0.1 mm larger or is not more than 0.03 mm larger than the outer diameter of the first sensing element in a region of the first section; and/or
wherein the first section encloses the first sensing element over a length of:
at least 1 mm; or
at least 8 mm; or
at least 10 mm, and
wherein the first section is tightly sealed circumferentially over the length against the first sensor element via the solder joint.

8. The temperature sensor according to claim 6, wherein the first section of the first channel is followed by the intermediate section, wherein the intermediate section has a larger inner diameter than the first section, and wherein the first solder reservoir is formed by a transition region or step between the first section and the intermediate section.

9. The temperature sensor according to claim 8, wherein the inner diameter of the intermediate section is at least 0.05 mm larger or at least 0.1 mm larger or at least 1 mm larger than the inner diameter of the first section (131) of the first channel (115).

10. The temperature sensor according to claim 1, wherein at least one of the fastening areas comprises a second section of the first channel and a connecting sleeve, wherein the connecting sleeve encloses the first sensing element in a defined manner, and wherein the second section of the first channel encloses the connecting sleeve in a defined manner and a second solder reservoir is located at one end of the second section.

11. The temperature sensor according to claim 10,
wherein the second section of the first channel has an inner diameter that is not more than 0.5 mm larger or is not more than 0.1 mm larger or is not more than 0.03 mm larger than the outer diameter of the connecting sleeve, and/or
wherein the connecting sleeve has an inner diameter that is not more than 0.5 mm larger or is not more than 0.1 mm large, or is not more than 0.03 mm larger than the outer diameter of the first sensing element, and/or
wherein the second section of the first channel and the connecting sleeve enclose the first sensing element over a length of at least 1 mm or at least 8 mm or at least 10 mm and, circumferentially over this length, the second section is tightly connected at least to the connecting sleeve and the connecting sleeve is also tightly connected to the first sensing element via the solder joint.

12. The temperature sensor according to claim 1, wherein the proximal end of the support tube is connected to a connecting piece or includes the connecting piece.

13. The temperature sensor according to claim 12, wherein the support tube is integrally connected to the connecting piece, or wherein the connecting piece has a passage and the proximal end of the support tube is disposed in or on the passage and is connected to the connecting piece by a screw connection and/or a solder joint and/or a vacuum brazed joint and/or one or more welded joints.

14. The temperature sensor according to claim 12, wherein the connecting piece has a passage and the proximal end of the support tube is arranged in or on this passage and is connected to the connecting piece by welded joints on both sides of the passage, wherein the connecting piece has a test bore extending from one side of the connecting piece, facing away from the distal end of the support tube into a space formed between the passage of the proximal end and the welded joints, or a test bore is formed on the proximal end of the support tube, which is connected to the intermediate section, and wherein the connecting piece has access to the test bore.

15. The temperature sensor according to claim 2, wherein a test bore is formed on the proximal end of the support tube, which is connected to the intermediate section.

16. The temperature sensor according to claim 1,
wherein the support tube comprises:
at least a second distal opening on the distal end;
at least a second proximal opening on the proximal end;
at least a second channel, which extends between the second distal opening and the second proximal opening; and
at least a second sensing element,
wherein the second sensing element is inserted through the second proximal opening into the second channel and passes through it, so that a measuring tip of the second sensing element passes through the second distal opening and protrudes beyond the distal end of the support tube, at least in sections,
wherein the support tube has a third fastening area on or near the distal end and has a fourth fastening area on or near the proximal end, and
wherein the second sensing element is directly or indirectly tightly sealed to the support tube by solder joints on the third and fourth fastening areas.

17. The temperature sensor according to claim 16, wherein a second intermediate section of the second channel extends between the third and fourth fastening areas, wherein the support tube and the second sensing element are not connected along the second intermediate section.

18. A method of producing the temperature sensor according to claim 1, the method comprising:
providing a support tube with a distal end having a first distal opening, with a proximal end having a first proximal opening and with a first channel, which extends between the first distal opening and the first proximal opening,
inserting a sensing element into the first channel through the first proximal opening so that the first sensing element passes through the first channel and a measuring tip of the first sensing element passes through the first distal opening and protrudes beyond the distal end of the support tube, at least in sections, wherein a first fastening area is located on or near the distal end and a second fastening area is located on or near the proximal end, and
producing solder joints between the support tube and the first sensing element on the first and second fastening areas.

19. The method according to claim 18,
wherein the first fastening area comprises a first section of the first channel, which encloses the support tube in a defined manner,
wherein a first solder reservoir is arranged at one end of the first section, wherein the second fastening area comprises a second section of the first channel and a connecting sleeve,
wherein the connecting sleeve encloses the first sensing element in a defined manner and the second section encloses the connecting sleeve in a defined manner, and
wherein a second solder reservoir is arranged at one end of the second section, and
wherein the following steps are performed between step of providing a support tube and the step of inserting a sensing element:
placing solder material in or on the first solder reservoir, and/or
placing solder material in or on the second solder reservoir.

20. The method according to claim 19, wherein the first solder reservoir and the second solder reservoir are arranged either both at one end of the first section or the second section, respectively, facing away from the distal end or both at one end facing the distal end, and wherein the step of producing solder joints comprises:
aligning the temperature sensor so that the first solder reservoir is located vertically above the first section and the second solder reservoir is located vertically above the second section, and
performing a soldering process.

21. The method according to claim 18, wherein the solder joints are produced as vacuum brazed joints in a soldering process or as a vacuum brazing process.
